(19) United States
(12) Patent Application Publication
(10) Pub. No.: US 2005/0219632 A1
(43) Pub. Date: Oct. 6, 2005

(54) Image processing system and image processing method

(75) Inventors: Yoichiro Maki, Nagano-ken (JP); Hideyuki Narusawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/948,467

(22) Filed: Sep. 24, 2004

(30) Foreign Application Priority Data
Sep. 26, 2003 (JP) 2003-336136
Mar. 3, 2004 (JP) 2004-059460
May 31, 2004 (JP) 2004-160474
Sep. 21, 2004 (JP) 2004-273329

(51) Int. Cl. H04N 1/409

(52) U.S. Cl. 358/3.26

(57) ABSTRACT

An image processing system has an image acquisition unit for acquiring a scanned image, a first scan area specifying unit for specifying a first scan area corresponding to an object on the basis of the scanned image, a recognizing unit for recognizing that the first scanned area object is a known object, and a second scan area specifying unit for specifying a second scan area obtained by removing from the first scan area at least a part of a shadow area presumed to correspond to a shadow of the known object. The system makes it possible to eliminate from a copy of an object with thickness such as a CD or a book the shadow cast by the object when it is illuminated by a scanner in the copying process.

### CROSS-REFERENCES TO RELATED APPLICATIONS

The entire disclosures, including the specifications, drawings and abstracts, of Japanese Patent Application No. 2003-336136 (application date Sep. 26, 2003), Japanese Patent Application No. 2004-059460 (application date Mar. 3, 2004), Japanese Patent Application No. 2004-160474 (application date May 31, 2004) and Japanese Patent Application No. 2004-273329 (application date Sep. 21, 2004) are incorporated in this application by reference.

### BACKGROUND OF THE INVENTION

### DESCRIPTION OF RELATED ART

So-called flat bed type copiers having an image reading function and a printing function that can copy the label of a Compact Disc (CD) are known (for example JP-A-2004-199489, JP-A-2003-1873).

However, in such copiers in related art, there has been the problem that a shadow of a CD placed on a document bed and illuminated from below the document bed is cast onto the document backing mat, and this shadow is printed on the CD label as the print medium. Also, in copiers in related art, because generally the sampling pitch at the time of reading is slightly different in the main scanning direction and the auxiliary scanning direction, there has been the problem that the image of the hard copy of the CD label distorts with respect to the image of the original CD label. And there has been the problem that with this as the cause, in a CD obtained by hard-copying a CD label, an unwanted blank area is formed on the CD label, and ink adheres to areas outside the label area.

### SUMMARY OF THE INVENTION

It is therefore an object of the present invention to provide an image processing system and an image processing method with which it is possible to correct a scanned image so as to reproduce a known scan object faithfully.

(1) To achieve this object and other objects, an image processing system according to the invention comprises: an image acquisition unit for acquiring a scanned image; a first scan area specifying unit for specifying a first scan area corresponding to an object on the basis of the scanned image; a recognizing unit for recognizing that the object is a known object; and a second scan area specifying unit for specifying a second scan area obtained by removing from the first scan area at least a part of a shadow area presumed to correspond to a shadow of the known object.

If an object has a significant thickness, when the object is illuminated and read, a shadow of the object is read as image. If the object and the lighting environment at the time of reading of the object are known, the shape of the shadow can be predicted. With this invention, because a first scan area corresponding to a known object is specified on the basis of a scanned image and then a second scan area obtained by removing a shadow area presumed to correspond to a shadow of the known object from the first scan area is specified, it is possible to correct the scanned image so that the known object is reproduced faithfully. The scan areas can be defined on the coordinate plane on which the scanned image is defined or may be defined on the coordinate plane on which the reading area is defined.

(2) The first scan area specifying unit may specify the first scan area by area division of the scanned image.

If the object is known, it is possible to specify a first scan area in which an area corresponding to the known object is included on the basis of the scanned image by area division using a threshold value corresponding to the characteristics of the object. With this invention, because the first scan area is specified by area division of the scanned image, it is not necessary for the user to be required to specify the first scan area in an interactive mode. Consequently, the invention makes it possible to cut down the operating procedures of an image processing system.

(3) The recognizing unit may recognize that the object is the known object by a characteristic analysis of the scanned image in the first scan area.

If the object is known, the object can be recognized as a known object by a characteristic analysis of the scanned image. Therefore, with this invention, it is not necessary for the user to be required to specify whether or not the object is a known object. Consequently, with this invention it is possible to cut down the operating procedures of an image processing system.

(4) The recognizing unit may accept an object-designating user operation and recognize that the object is the first scan area known object in response to the object-designating user operation.

When the user is required to designate the object appearing in the scanned image, it is not necessary to determine whether or not the object is a known object by image analysis. Therefore, in this case, it is possible to reduce the image analysis load of the image processing system.

(5) The image processing system may further comprise a distortion correcting unit for correcting the ratio of the longitudinal direction length to the cross direction length of the scanned image in the second scan area by resizing it on the basis of preset distortion correction information.

Generally, the ratio of the sampling spacing at the time of reading of the original and the display spacing of the pixels of the scanned image is slightly different in the main scanning direction and the auxiliary scanning direction. Therefore, generally, the longitudinal/cross ratio of the object displayed with the scanned image and the longitudinal/cross ratio of the actual object are slightly different. If the respective relationships between the sampling spacing at the time of reading of the original and the display spacing of the pixels of the scanned image are known for the main scanning direction and the auxiliary scanning direction, in accordance with those relationships it is possible to correct the distortion of the scanned image so that the ratio of the sampling spacing and the display spacing of the pixels of the scanned image is the same in the main scanning direction and the auxiliary scanning direction. In this invention, the ratio of the longitudinal direction length and the cross direction length of the second scan area corresponding to the known object is corrected by resizing on the basis of preset distortion correction information. Consequently, with this invention, it is possible to make the longitudinal/cross ratio of the known object displayed on the basis of the scanned image exactly the same as the longitudinal/cross ratio of the actual object. (In this specification document, ‘display’ is used to mean both print display and screen display.)

(6) The image acquisition unit may acquire the scanned image from an image reading device that reads an object placed on a transparent document bed and covered by a document backing mat and illuminated from a direction making a specified angle with a perpendicular line to the plate face of the document bed, and the shadow area may be an area predetermined in correspondence with the shape of the known object and the specified angle.

(7) The image processing system may further comprise a reading unit for reading the known object and outputting the scanned image to the image acquisition unit and a printing unit for carrying out printing on the basis of print data created on the basis of the scanned image in the second scan area.

(8) The known object may be annular in shape. In this case, the image processing system may further comprise a print data creating unit for, on the basis of the scanned image in the second scan area, creating print data in which areas corresponding to outside of an annular third area within the second scan area and concentric with the second scan area are masked as non-print areas.

When the shape of the scan object is annular, with this invention, it is possible to prevent unnecessary coloring material such as ink or toner from adhering to the print medium or a platen by creating print data in which areas corresponding to outside of an annular third area within the second scan area and concentric with the second scan area are masked as non-print areas. Here, the areas outside the annular area are an area outward of the outer boundary of the annular area and an area inward of the inner boundary of the annular area.

(9) The known object may be annular in shape. In this case, the image processing system may further include a transparency conversion unit for converting to transparent the scanned image outside of an annular area within the second scan area and concentric with the second scan area.

When the shape of the scan object is annular, with this invention, it is possible to prevent unnecessary coloring material such as ink or toner from adhering to the print medium or a platen by converting areas outside of an annular third area within the second scan area to transparent.

(10) The known object may be a Compact Disc.

With this invention, it is possible to correct the scaned image so that a Compact Disc is reproduced faithfully.

(11) To achieve this object and other objects, another image processing system provided by the invention includes: an image acquisition unit for acquiring a scanned image;
a first scan area specifying unit for specifying a first scan area corresponding to an object on the basis of the scanned image; a recognizing unit for recognizing that the object is a known object; and a distortion correcting unit for correcting the ratio of a longitudinal direction length to a cross direction length of the scanned image in the first scan area by resizing it on the basis of preset distortion correction information.

With this invention, the ratio of the longitudinal direction length to the cross direction length of the scanned image in the first scan area corresponding to the known object is corrected by the scanned image being resized on the basis of preset distortion correction information. Consequently, with this invention, it is possible to make the longitudinal/cross ratio of the known object displayed with the scanned image exactly the same as the longitudinal/cross ratio of the actual object.

(12) The first scan area specifying unit may specify the first scan area by area division of the scanned image.

With this invention, because the first scan area is specified by area division of the scanned image, it is not necessary for the user to be required to specify the first scan area in an interactive mode. Consequently, the invention makes it possible to cut down the operating procedures of an image processing system.

(13) The known object may be annular in shape. In this case, the image processing system may further include a print data creating unit for on the basis of the scanned image in the first scan area creating print data in which areas corresponding to outside of an annular second scan area within the first scan area and concentric with the first scan area are masked as non-print areas.

When the shape of the scan object is annular, with this invention, it is possible to prevent unnecessary coloring material such as ink or toner from adhering to the print medium or a platen by creating print data in which areas corresponding to outside of an annular second scan area within the first scan area are masked as non-print areas.

(14) The known object may be annular in shape. In this case, this image processing system may further include a transparency conversion unit for converting to transparent the scanned image outside of an annular second scan area within the first scan area and concentric with the first scan area.

When the shape of the scann object is annular, with this invention, it is possible to prevent unnecessary coloring material such as ink or toner from adhering to the print medium or a platen by converting areas outside of an annular second area within the first scan area to transparent.

(15) This image processing system may further include a reading unit for reading the known object and outputting the scanned image to the image acquisition unit and a printing unit for carrying out printing on the basis of print data created on the basis of the scanned image in the first scan area.

(16) The recognizing unit may recognize that the object is the known object by a characteristic analysis of the scanned image in the first scan area.

In this case, it is not necessary for the user to be required to specify whether or not the object is a known object. Consequently, it is possible to cut down the operating procedures of the image processing system.

(17) The recognizing unit may accept an object-designating user operation and recognize that the object is the known object in response to the object-designating user operation.

When the user is required to designate the object, it is unnecessary to specify whether or not the object is a known object by image analysis. Therefore, it is possible to reduce the image analysis load of the image processing system.

(18) The known object may be a Compact Disc.

With this invention, the scanned image can be corrected so that the Compact Disc is reproduced faithfully.

(19) The invention also provides an image processing method, including: an image acquisition step of acquiring a scanned image; a first scan area specifying step of specifying a first scan area corresponding to an object on the basis of the scanned image; a recognizing step of recognizing that the object is a known object; and a second scan area specifying step of specifying a second scan area obtained by removing from the first scan area at least a part of a shadow area presumed to correspond to a shadow of the known object.

(20) And the invention also provides an image processing method including: an image acquisition step of acquiring a scanned image; a first scan area specifying step of specifying a first scan area corresponding to an object on the basis of the scanned image; a recognizing step of recognizing that the object is a known object; and a distortion correcting step of correcting the ratio of the longitudinal direction length to the cross direction length of the first scan area by resizing on the basis of preset distortion correction information.

The functions of the multiple units provided in the invention are realized by means of hardware resources whose functions are specified by their own constructions, hardware resources whose functions are specified by programs, or a combination of these. Also, the functions of these units do not have to be realized by physically independent hardware resources.

The invention can not only be specified as a device and method invention but can also be specified as a program invention or an invention of a recording medium on which such a program is recorded.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIGS. 1A through 1E are schematic views showing a scanned image pertaining to a first embodiment of the invention;

FIG. 2 is a perspective view showing the exterior of a copier according to the first embodiment of the invention;

FIG. 3 is a block diagram of a copier according to the first embodiment of the invention;

FIG. 4 is a schematic view of a scanning unit pertaining to the first embodiment of the invention;

FIG. 5 is a block diagram of a control program according to the first embodiment of the invention;

FIG. 6 is a flow chart showing an image processing method according to the first embodiment of the invention;

FIGS. 7A through 7E are schematic views showing a scanned image pertaining to the first embodiment of the invention;

FIG. 8 is a schematic view illustrating the creation of a print object page in the first embodiment of the invention;

FIG. 9 is a flow chart showing an image processing method according to a second embodiment of the invention;

FIG. 10 is a schematic view showing a scanned image pertaining to a second embodiment of the invention;

FIG. 11 is a schematic view illustrating the creation of a print object page in the second embodiment of the invention; and

FIG. 12 is a flow chart showing an image processing method according to a third embodiment of the invention.

### DETAILED DESCRIPTION OF THE PREFERRED EMBODIMENTS

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention. Constituent parts having been assigned the same reference numerals in different preferred embodiments are equivalent.

### First Embodiment

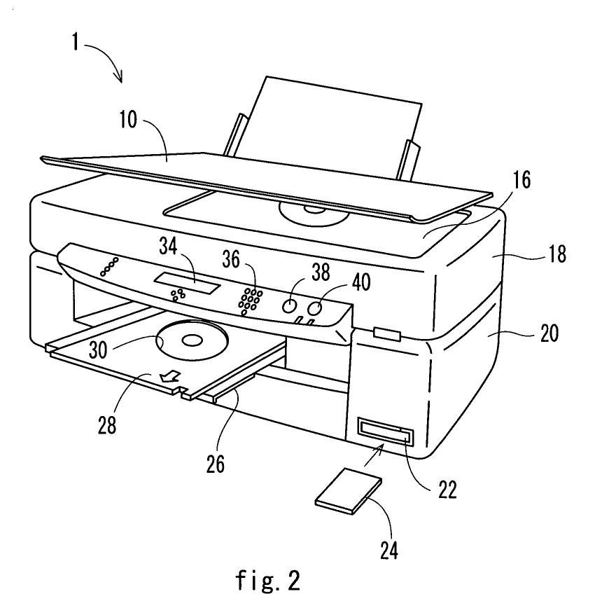

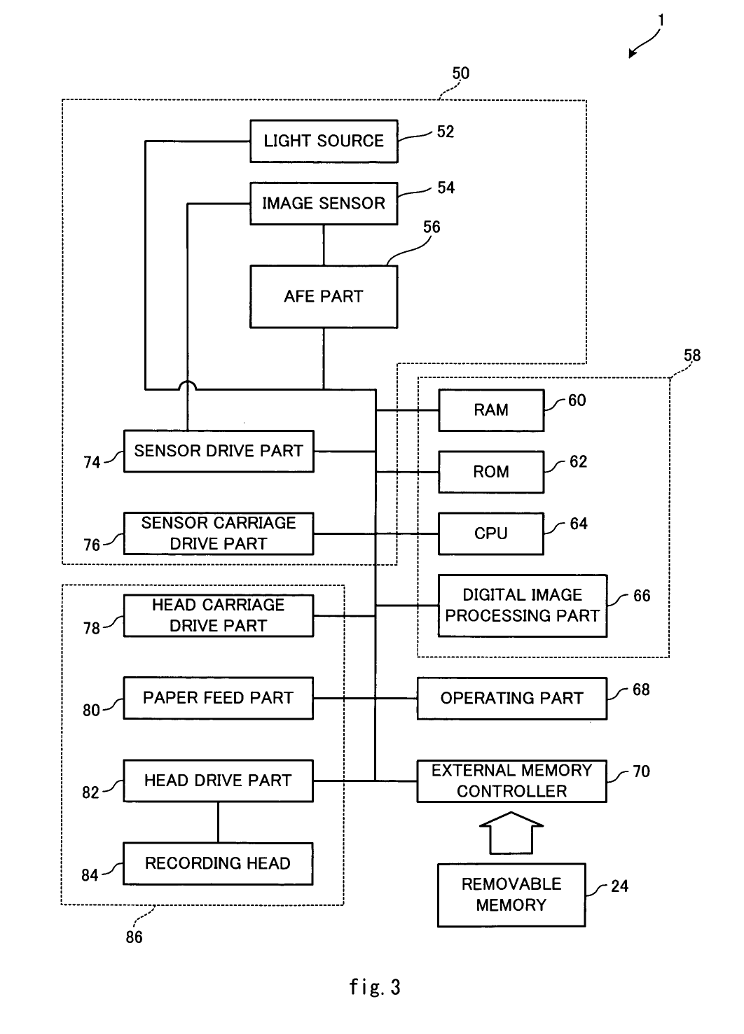

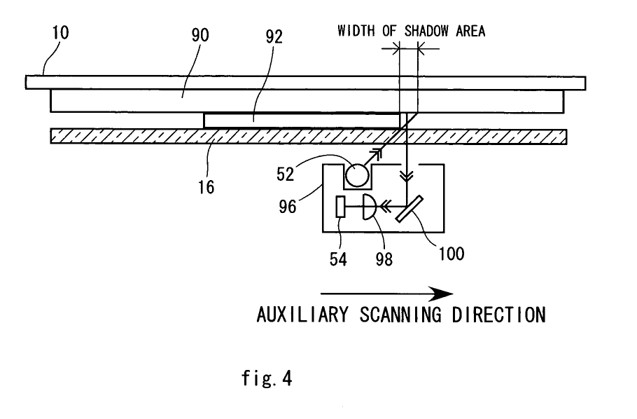

FIG. 2 is a perspective view showing the exterior of a copier 1 constituting a first preferred embodiment of an image processing system according to the invention. FIG. 3 is a block diagram of the copier 1. FIG. 4 is a schematic view showing the construction of a scanning unit 50 of the copier 1. The copier 1 has a function of outputting image data obtained by reading an original document to a personal computer (PC) (not shown), a function of printing image data inputted from a removable memory 24 or from a PC, and a function of printing image data obtained by reading an original document.

The scanning unit 50, which is a reading unit, is housed in an upper case 18, and has a light source 52, an image sensor 54, an AFE (Analog Front End) part 56, a sensor drive part 74, and a sensor carriage drive part 76. The light source 52 consists of a fluorescent lamp or the like that is long in a main scanning direction. The image sensor 54, which is driven by the sensor drive part 74, is a linear image sensor such as a color CCD linear image sensor having an RGB 3-channel light-receiving device. The image sensor 54 is mounted on a sensor carriage 96 that moves parallel to a transparent document bed 16. The image sensor 54 outputs an electrical signal correlating with the light and shade of an optical image of an object 92 formed on a light-receiving surface by a lens 98 and a mirror 100. The sensor carriage drive part 76 has a motor, a drive belt and a driving circuit and so on (not shown). The sensor carriage drive part 76 moves the sensor carriage 96 back and forth along a guide rod (not shown) mounted perpendicular to the length direction of a main scanning area. The image sensor 54 can read a two-dimensional image by moving in a direction perpendicular to the length direction of the main scanning area. The AFE part 56 has an analog signal processing part for amplification, noise removal and so on, and an A/D-convertor. The scanning unit 50 may be of the lens reduction type construction described above or alternatively of a contact type construction.

A print unit 86 of the copier 1 is housed in a lower case 20 and has a recording head 84, a head drive part 82, a head carriage drive part 78, a paper feed part 80 and the like for forming an image on a print medium by the ink jet method. The print unit 86 may alternatively be of a construction corresponding to some other printing method, such as the laser method. The recording head 84 is mounted on a head carriage (not shown) fitted with an ink cartridge, and has a nozzle, a piezoelectric device, an ink passage and so on. The head carriage drive part 78 has a motor, a drive belt, a drive circuit (not shown) and so on. The head carriage drive part 78 moves the recording head 84 back and forth perpendicular to a longitudinal feed direction of the print medium. The paper feed part 80 has paper feed rollers, a motor, a drive circuit and so on. By rotating the paper feed rollers, the paper feed part 80 carries copy paper or a CD tray 28 (see FIG. 2) in a direction perpendicular to the axis of movement of the recording head 84. The print unit 86 is so constructed that it can carry the CD tray 28 and form an image on a label face of a CD positioned in a positioning part 30 of the CD tray 28.

An external memory controller 70 is connected to a removable memory 24 inserted into a card slot 22 (see FIG. 2). Data held on the removable memory 24 is read out by the external memory controller 70 and passed on to a RAM 60.

An operating part 68 has an LCD 34 for displaying menus and various push-buttons 36, 38 and 40 as scrolling keys, a selecting key and a cancel key and so on for operating the menus.

A control part 58 has the RAM 60, a ROM 62, a CPU 64 and a digital image processing part 66. The CPU 64 controls the various parts of the copier 1 by executing control programs held in the RAM 60. The ROM 62 is nonvolatile memory for storing control programs. The RAM 60 is volatile memory in which various data such as control programs and scanned images are held temporarily. Control programs may also be obtained from a remote server and stored in the ROM 62 via a network or may be stored in the ROM 62 via a computer-readable recording medium such as the removable memory 24. The digital image processing part 66 is a dedicated circuit such as a DSP circuit that constitutes a part of a reading unit and a printing unit and executes image-processing of the scanned image such as gamma correction, resolution conversion, image color balance correction, binarization and conversion of color spaces in cooperation with the CPU 64.

The foregoing is description of the hardware construction of the copier 1. Next, shadows appearing in scanned images is discussed.

As shown in FIG. 4, the light source 52 is mounted in a position off a light path leading from the image sensor 54 to the plate face of the document bed 16. From a direction forming a specified angle with a line perpendicular to the plate face of the document bed 16, the light source 52 illuminates a main scanning area on the document bed 16 constituting an area an image of which is formed at the image sensor 54, which is in a specified position. Consequently, when the object 92 is thick, a shadow of the object 92 illuminated by the light source 52 is formed on a document backing mat 90 fixed to the document cover 10, and this shadow appears in the scanned image.

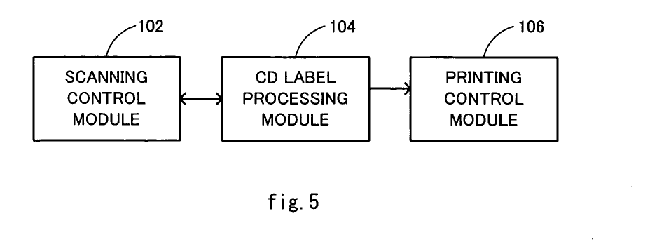

FIG. 5 is a block diagram of a control program of the copier 1.

A scanning control module 102 is a program component for making the control part 58 function as an image acquisition unit. The scanning control module 102 controls the scanning unit 50 in response to a read start request and stores a scanned image in the RAM 60.

A CD label processing module 104 is a program component for making the control part 58 function as a first scan area specifying unit, a recognizing unit, a second scan area specifying unit, and a distortion correcting unit.

The CD label processing module 104 specifies a first scan area by area division of a low-resolution scanned image acquired by a first reading. Hereinafter, the low-resolution scanned image acquired by the first reading will be called ‘the first scanned image’. For the area division, a threshold value at a level obtained by subtracting a predetermined margin from the shade level of the pixels corresponding to the document backing mat 90 is used. The CD label processing module 104 recognizes that the object is a CD by a characteristic analysis of the first scanned image. In the characteristic analysis, for example it analyzes whether or not the shape of the first scan area matches the standard dimensions of a CD.

On the basis of clipping information, the CD label processing module 104 cuts off an area corresponding to the outside of a second scan area of a high-resolution scanned image acquired by a second reading. Hereinafter, the high-resolution scanned image acquired by the second reading will be called ‘the second scanned image’. The clipping information is information set in accordance with the auxiliary scanning direction, the angle formed by the light path leading from the light source 52 to the main scanning area and the light path leading from the main scanning area to the image sensor 54, and the diameter and thickness of a CD stipulated as standard dimensions, and is stored in the ROM 62 in advance. The clipping information is information for specifying what percentage of the diameter of the CD in the scanned image is the maximum width of the shadow that appears in the scanned image on the front or rear side of the CD in the auxiliary scanning direction. The clipping information maybe set as a ratio if the resolution of reading the CD is variable and be set as a number of pixels if the CD reading resolution is known.

The CD label processing module 104 resizes the second scanned image in accordance with a printing resolution. At this time the CD label processing module 104 resizes the second scanned image by different factors in the longitudinal and cross directions, on the basis of distortion correction information, and thereby deforms the second scanned image to a square of a size corresponding to the printing resolution and the size of the print area. The distortion correction information is information set in correspondence with the ratio of the sampling spacing in the main scanning direction to the sampling spacing in the auxiliary scanning direction at the time of reading, and stored in the ROM 62 in advance. The distortion correction information is set on the basis that the pixel spacing at the time of display is the same in the main scanning direction and the auxiliary scanning direction. Consequently, by resizing the second scanned image in accordance with the ratio of the sampling spacing in the main scanning direction to the sampling spacing in the auxiliary scanning direction at the time of reading, it is possible to make the longitudinal/cross ratio of the actual object and the longitudinal/cross ratio of the displayed object the same.

The CD label processing module 104 is a program component for making the control part 58 function as a transparency conversion unit. The CD label processing module 104 creates a printing object page on the basis of a template pre-stored in the ROM 62 and the second scanned image. This template is made up of a mask corresponding to the shape of a CD label and position information for superimposing the second scanned image and the mask on a page in a predetermined position. The mask is two-dimensional array information for changing non-print pixels to a transparent level or setting non-print pixels as pixels that do not need to be printed.

A printing control module 106 is a program component for making the control part 58 and the print unit 86 function as a printing unit and a print data generating unit. The printing control module 106 creates print data by carrying out processing to convert the color space of the print object page to a color space of ink such as CMYK, binarization processing, interlacing and so on, and controls the print unit 86 on the basis of the print data.

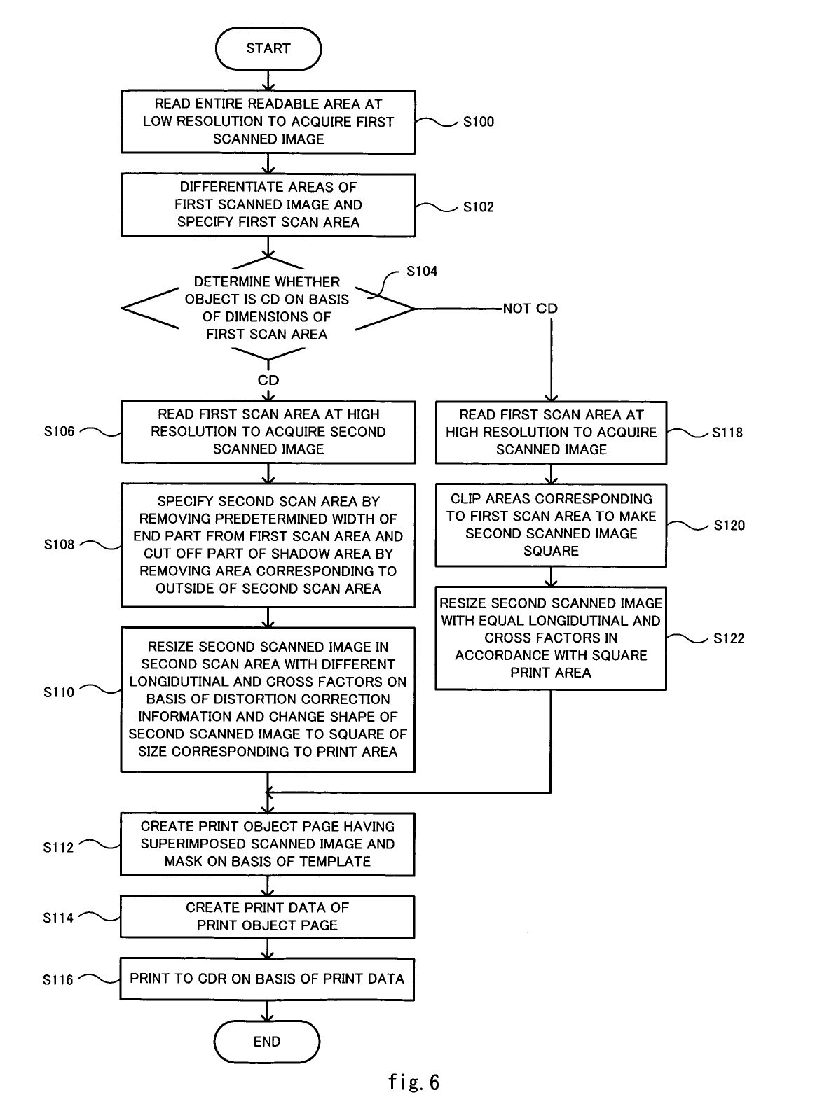

FIG. 6 is a flow chart showing an image processing method used by a copier 1 in which the control part 58 executes the control program described above. The processing shown in FIG. 6 is started when the copier 1 change to a CD copy mode by a predetermined menu operation.

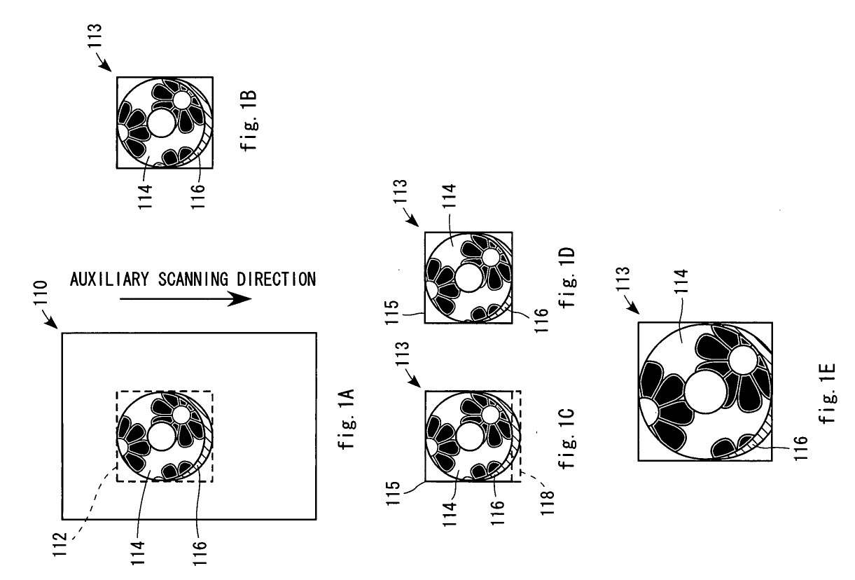

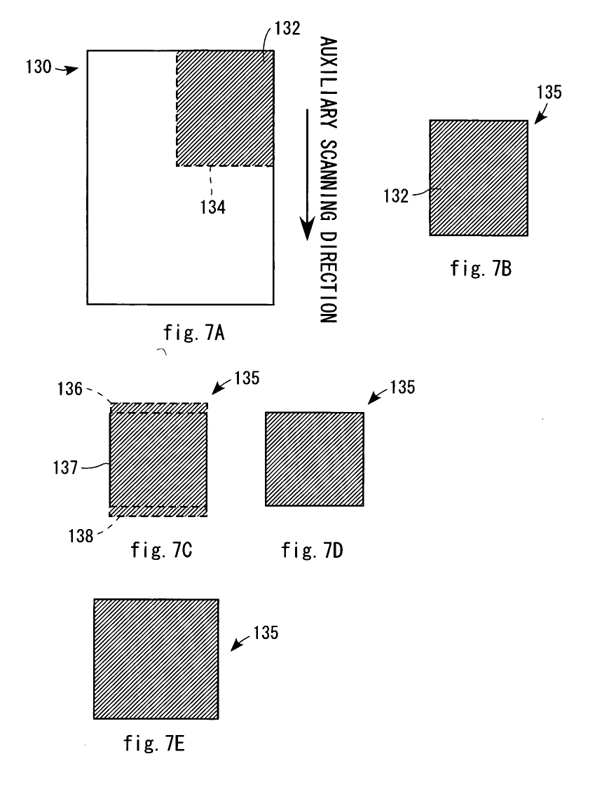

In step S100, the control part 58 executes the scanning control module 102, and when a CD copy start request is received as a result of a predetermined menu operation, the whole readable area of the document bed 16 is read at a low resolution by the scanning unit 50 and a first scanned image is stored in the RAM 60. FIG. 1A shows a first scanned image 110 taken in the condition with a CD placed on the document bed 16. In the first scanned image 110, a CD 114 and a CD's shadow 116 appear. FIG. 7A shows a first scanned image 130 taken in the condition with a thin object such as a piece of paper placed on the document bed 16. In the first scanned image 130, a thin object 132 appears but no shadow of the thin object 132 appears.

In step S102, the control part 58, executing the CD label processing module 104, specifies the area of the object 114, 132 by area division of the first scanned image, and also specifies a first scan area 112, 134 equivalent to the rectangle circumscribing the area of the object 114, 132. When the object is a CD, because the shade level of the area corresponding to the CD's shadow 116 is considerably lower than the shade level of the area corresponding to the document backing mat 90, the areas corresponding to the CD 114 and the CD's shadow 116 are both included in the first scan area 112, as shown in FIG. 1A. Although in FIGS. 1A to 1E and FIGS. 7A to 7E a first scan area 112, 134 and a second scan area 115, 137 are shown superimposed on the first scanned image 110, 130 and the second scanned image 113, 135, in reality the first scan area 112, 134 and the second scan area 115, 137 are areas on the document bed 16. Next, the control part 58 sets the first scan area 112, 134 as a second reading area. As the method for specifying the objects 114, 132, besides area division using a shade level threshold value, edge detection may alternatively be used.

In step S104, the control part 58, executing the CD label processing module 104, determines on the basis of the dimensions of the first scan area 112, 134 whether the object is a CD or something other than a CD. Specifically, for example the control part 58 determines whether the object is a CD or something other than a CD on the basis of whether or not the dimensions of the first scan area 112, 134 are 12 cm (±3%)×12 cm (±3%). When it determines that the object is a CD, the control part 58 proceeds to step S106, and when it determines that the object is not a CD it proceeds to step S118. As the characteristic of the CD used for specifying that the object is a CD, besides external dimensions, it is also possible to use for example whether there is a circular hole in the middle. When the object is specified by a characteristic analysis, it becomes unnecessary for the user to specify what the object is in an interactive mode, and it is possible to cut down the procedures of operating the copier 1.

In step S106 and step S118, executing the scanning control module 102, the control part 58 makes the scanning unit 50 read the read area set in step S102 at a high resolution and stores it as a second scanned image in the RAM 60. FIG. 1B shows a second scanned image 113 taken in the condition with a CD placed on the document bed 16. In the second scanned image 113, the CD 114 and the CD's shadow 116 appear. FIG. 7B shows a second scanned image 135 taken in the condition with a thin object such as a piece of paper placed on the document bed 16. In the second scanned image 135, the thin object 132 appears but no shadow of the thin object 132 appears.

In step S108 executed when the object is a CD, the control part 58, executing the CD label processing module 104, specifies a second scan area 115 obtained by removing a predetermined width of one end of the first scan area 112 on the basis of the above-mentioned clipping information (see FIG. 1C), and cuts off an area of the second scanned image 113 corresponding to the outside areas 118 of the second scan area 115. As a result, a part of the area corresponding to the CD's shadow 116 is removed from the second scanned image 113, and the second scanned image 113 is changed in shape as shown in FIG. 1D.

In step S110 executed when the object is a CD, the control part 58, executing the CD label processing module 104, resizes the second scanned image 113 in the second scan area 115 on the basis of the above-mentioned distortion correction information and deforms the second scanned image 113 to a square of a size corresponding to the size of the print area and the printing resolution (see FIG. 1E). Since the second scanned image 113 being resized by different factors in the longitudinal and cross directions on the basis of distortion correction information preset in accordance with the characteristics of the scanning unit 50, the longitudinal/cross ratio of the original CD label image and the longitudinal/cross ratio of the CD label image printed with the copier 1 can be made exactly the same. And, a thin crescent-shaped blank area is prevented from forming on the CD label area 156 that is the print medium.

In step S120 executed when the object is not a CD, the control part 58 specifies a square area inscribing the first scan area 134 with its center of gravity at the center of the first scan area 134 (see FIG. 7C) as a second scanned area 137. The control part 58 also removes end parts 136, 138 corresponding to areas obtained by removing the second scan area 137 from the first scan area 134, and thereby changes the shape of the second scanned image 135 to square (see FIG. 7D).

In step S122 executed when the object is not a CD, the second scanned image 135 is resized by equal factors in the longitudinal and cross directions in accordance with the size of the print area.

In step S112, the control part 58, executing the CD label processing module 104, creates a print object page on the basis of the above-mentioned template and the second scanned image 113, 135.

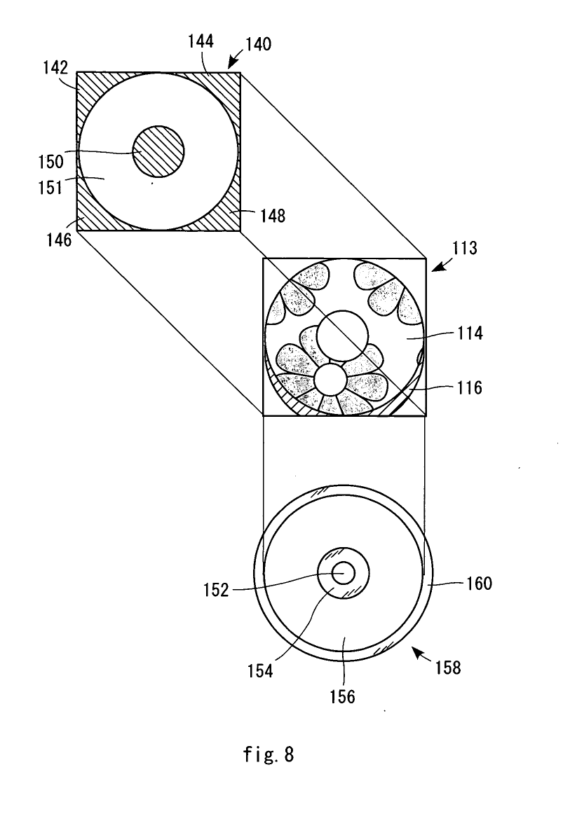

FIG. 8 is a schematic view illustrating the creation of a print object page using a template. A mask 140 constituting a template is set in accordance with the standard dimensions of a CD 158 and the printing resolution and pre-stored in the ROM 62. The mask 140 has corner areas 142, 146, 148, 144 and a circular central area 150 having values for setting pixels either to a transparent level or as not-to-be printed pixels, and an annular no-setting area 151 having values for not changing pixels. The diameter of the central area 150 is equal to the internal diameter of the CD label area 156 of the CD 158. The external diameter of the no-setting area 151 is equal to the external diameter of the CD label area 156 of the CD 158 and equal to the length of one side of the second scanned image 113, 135 on which the processing of up to step S110 or S122 has been carried out. When the mask 140 and the second scanned image 113 are superimposed on the print object page so that their respective centers of gravity coincide, a print object page is formed such that an image is formed only on the CD label area 156 of the CD 158. As a result, ink is prevented from adhering to an inner edge transparent part 154 of the CD 158, an outer edge transparent part 160 of the CD 158, a platen positioned directly below a central opening 152 in the CD 158, or the CD tray 28. The shape of the mask 140 does not have to be that described above, and for example it is possible to adopt a construction in which ink does not adhere to highly reflective areas positioned on the inner side and the outer side of the CD label area 156, a construction in which predetermined margins are set at the inner edge and the outer edge of the CD label area 156, and/or a construction in which the image is formed on the inner edge transparent part 154 and the outer edge transparent part 160 as well.

In step S114, the control part 58, executing the printing control module 106, creates print data by carrying out color space conversion, binarization and interlacing on the print object page.

In step S116, the control part 58, executing the printing control module 106, controls the print unit 86 on the basis of the print data to print an image on the CD 158 in the CD tray 28. As a result, an image of the object placed on the document bed 16 is printed on the CD 158. As the print medium on which the image of the object placed on the document bed 16 is printed, besides a CD 158, for example a plain seal having a peel-and-stick area corresponding to the CD label area 156 of the CD 158 can be used.

### Second Embodiment

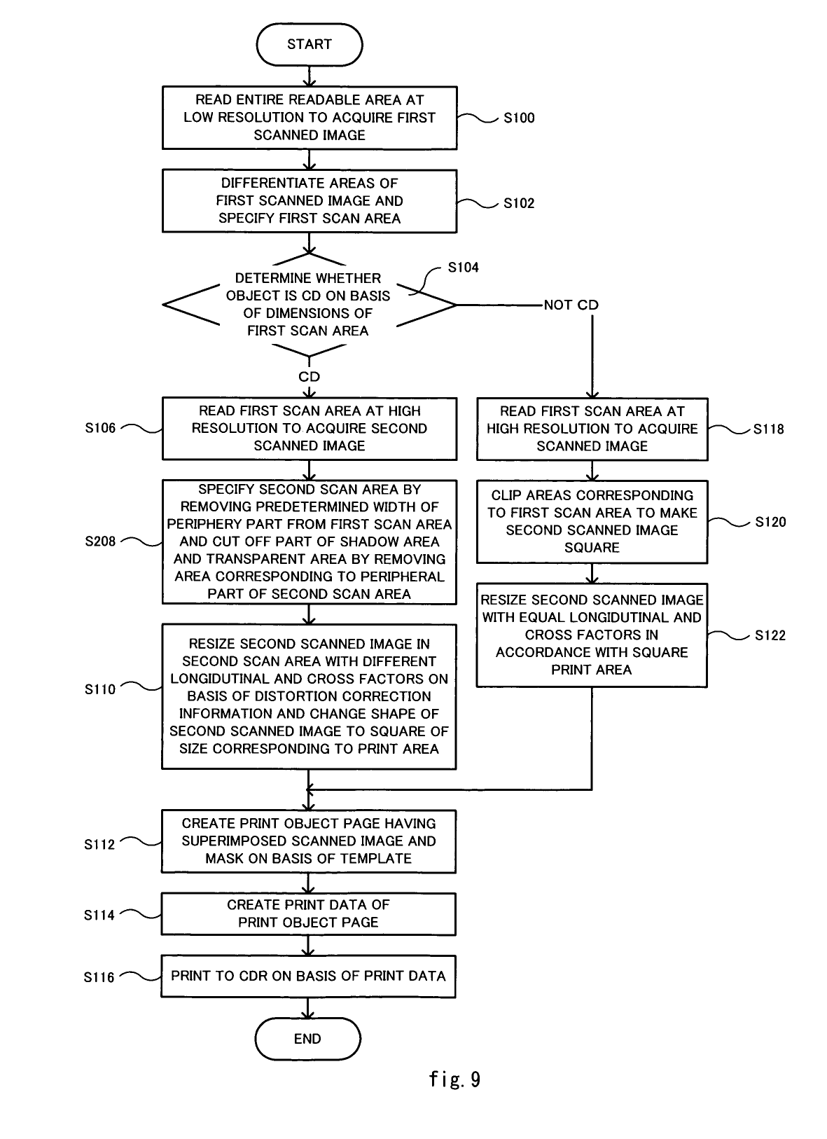

FIG. 9 is a flow chart showing an image processing method of a second preferred embodiment of the invention. This second preferred embodiment differs from the first preferred embodiment only in the clip processing of the second scan area, and otherwise is essentially the same as the first preferred embodiment. Hereinafter, details are described.

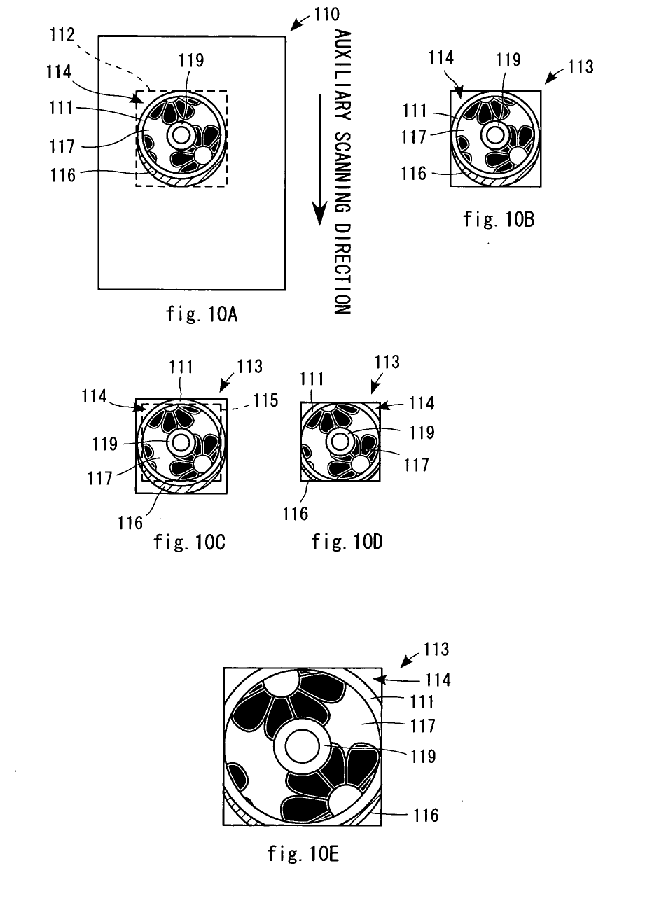

When the object is a CD, in the area division of the first scanned image in step S102, depending on the threshold value, a first scan area 112 of the kind shown in FIG. 10A may be set. In the first scanned image 110 taken in the first reading, the CD 114 and the CD's shadow 116 appear. In the area of the CD 114, an area 111 corresponding to a transparent part at the outer edge of the CD and an area 119 corresponding to a transparent part at the inner edge of the CD are included. The CD's shadow 116 is formed outside the area 111 corresponding to the transparent part at the outer edge of the CD.

As a result, in the step S106 of carrying out a second reading, the second scanned image 113 shown in FIG. 10B is acquired.

In step S208, the control part 58, executing the CD label processing module 104, specifies a second scan area 115 obtained by removing a predetermined width from the boundary of the first scan area 112 on the basis of clipping information (see FIG. 10C), and cuts off an area of the second scanned image 113 corresponding to an area outside the second scan area 115. The width cut off is set in accordance with the width of the transparent part of the CD, the thickness of the CD and the diameter of the CD. As a result, a part of the CD's shadow 116 and a part of the transparent part 111 of the CD are cut of from the second scanned image 113, and the second scanned image 113 changes in shape as shown in FIG. 10D.

In step S110, the second scanned image 113 shown in FIG. 10D is resized and deformed to a square corresponding to the size of the print area and the printing resolution.

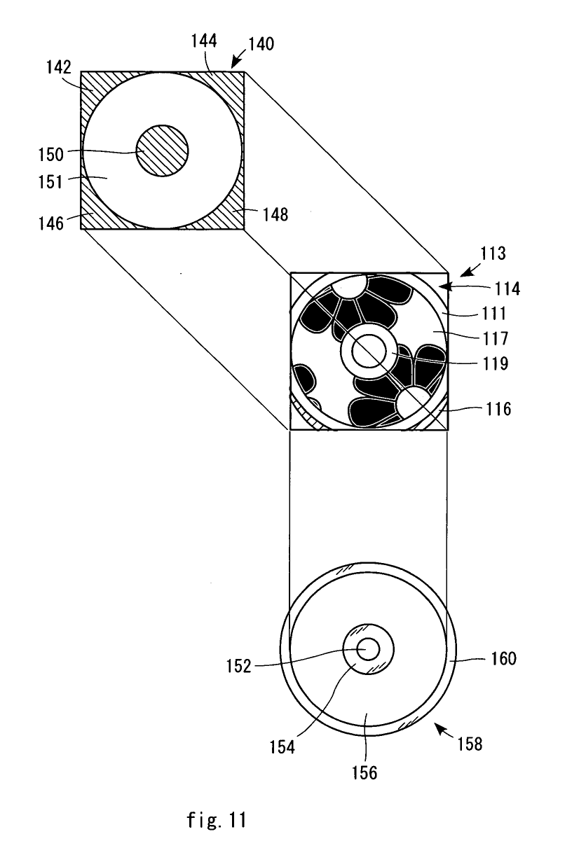

In step S112, a mask 140 and the second scanned image 113 are laid out on a print object page as shown in FIG. 11. The length of one side of the mask 140 corresponds to the external diameter of an annular opaque area 117 of the CD. The diameter of the circular central area 150 of the mask 140 corresponds to the internal diameter of the opaque area 117 of the CD. As a result, the transparent parts 111, 119 of the CD are prevented from being printed in a thin gray color or the like onto the CD label area 156.

### Third Embodiment

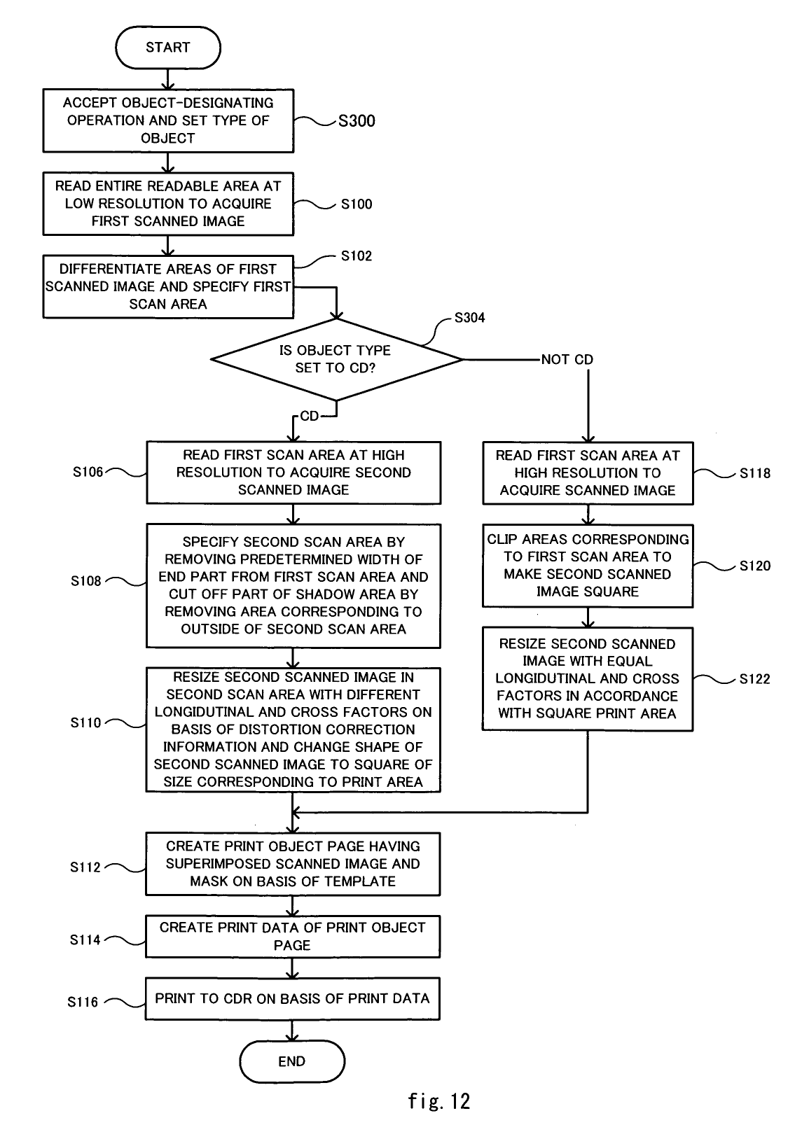

FIG. 12 is a flow chart showing an image processing method of a third preferred embodiment of the invention. This third preferred embodiment differs from the first preferred embodiment only in the method of identifying the object, and otherwise is essentially the same as the first preferred embodiment. Hereinafter, details are described.

In a step S300, the control part 58, executing the CD label processing module 104, accepts an object-designating operation as a predetermined menu operation and sets the type of the object in accordance with the object-designating user operation.

In step S304, the control part 58, executing the CD label processing module 104, determines whether the type of the object has been set to CD or has been set to something else, and if it has been set to CD then processing proceeds to step S106, and if it has been set to something other than CD then processing proceeds to step S118. That is, the control part 58 recognizes whether or not the object is a CD without performing a characteristic analysis of the first scanned image 110, 130 in the first scan area 112, 134. Consequently, in this third preferred embodiment, the time, and development/manufacturing costs spent on processing for characteristic analysis can be cut.

Although preferred embodiments in which the invention was applied to a copier 1 have been described, the invention can also be applied to a system made up of a PC and a printer and a scanner connected to the PC. The invention can also be applied to a system made up of a scanner capable of outputting scanned images to a removable memory and a printer capable of inputting images from the removable memory. In this case, an external memory controller provided in the printer constitutes a part of the image acquisition unit of the invention. The invention can also be applied to a system in which complete scanned images are stored in memory in a scanner system, the scanner creates a print object page on which are laid out the scanned image and a mask, and the scanner outputs print data of the print object page to an external printer. And the invention can also be applied to a printer that acquires a scanned image from a scanner, creates a print object page on which are laid out the acquired scanned image and a mask, creates print data on the basis of the print object page, and prints the scanned image.

And although in the preferred embodiments described above the example of a CD was used as the object, the object can be any known object that can be identified by its shape or some other characteristic on the basis of a standard or the like, and for example may be a book of a standard shape. When the object is a standard book, although the thickness of the object is not known, because generally there is a blank area around the periphery of the page, shadows can be removed using characteristics of the blank area of the page in the image. Needless to say, the CD referred to in the invention includes CDs of any of a number of standards such as CD, CD-R, CD-RW, and DVD.

Combinations and subcombinations of the various embodiments described above will occur to those familiar with this field, without departing from the scope and spirit of the invention.

FIG. 1
AUXILIARY SCANNING DIRECTION

FIG. 3
52 LIGHT SOURCE
54 IMAGE SENSOR
56 AFE PART
74 SENSOR DRIVE PART
76 SENSOR CARRIAGE DRIVE PART
78 HEAD CARRIAGE DRIVE PART
80 PAPER FEED PART
82 HEAD DRIVE PART
84 RECORDING HEAD
66 DIGITAL IMAGE PROCESSING PART
68 OPERATING PART
70 EXTERNAL MEMORY CONTROLLER
24 REMOVABLE MEMORY

FIG. 4
WIDTH OF SHADOW AREA
AUXILIARY SCANNING DIRECTION

FIG. 5
102 SCANNING CONTROL MODULE
104 CD LABEL PROCESSING MODULE
106 PRINTING CONTROL MODULE

FIG. 6
START
S100 READ ENTIRE READABLE AREA AT LOW RESOLUTION TO ACQUIRE FIRST SCANNED IMAGE
S102 DIFFERENTIATE AREAS OF FIRST SCANNED IMAGE AND SPECIFY FIRST SCAN AREA
S104 DETERMINE WHETHER OBJECT IS CD ON BASIS OF DIMENSIONS OF FIRST SCAN AREA
CD NOT CD
S106 READ FIRST SCAN AREA AT HIGH RESOLUTION TO ACQUIRE SECOND SCANNED IMAGE
S108 SPECIFY SECOND SCAN AREA BY REMOVING PREDETERMINED WIDTH OF END PART FROM FIRST SCAN AREA AND CUT OFF PART OF SHADOW AREA BY REMOVING AREA CORRESPONDING TO OUTSIDE OF SECOND SCAN AREA
S110 RESIZE SECOND SCANNED IMAGE IN SECOND SCAN AREA WITH DIFFERENT LONGIDUTINAL AND CROSS FACTORS ON BASIS OF DISTORTION CORRECTION INFORMATION AND CHANGE SHAPE OF SECOND SCANNED IMAGE TO SQUARE OF SIZE CORRESPONDING TO PRINT AREA
S112 CREATE PRINT OBJECT PAGE HAVING SUPERIMPOSED SCANNED IMAGE AND MASK ON BASIS OF TEMPLATE
S114 CREATE PRINT DATA OF PRINT OBJECT PAGE
S116 PRINT TO CDR ON BASIS OF PRINT DATA
END
S118 READ FIRST SCAN AREA AT HIGH RESOLUTION TO ACQUIRE SCANNED IMAGE
S120 CLIP AREAS CORRESPONDING TO FIRST SCAN AREA TO MAKE SECOND SCANNED IMAGE SQUARE
S122 RESIZE SECOND SCANNED IMAGE WITH EQUAL LONGIDUTINAL AND CROSS FACTORS IN ACCORDANCE WITH SQUARE PRINT AREA

FIG. 7
AUXILIARY SCANNING DIRECTION

FIG. 9
START
S100 READ ENTIRE READABLE AREA AT LOW RESOLUTION TO ACQUIRE FIRST SCANNED IMAGE
S102 DIFFERENTIATE AREAS OF FIRST SCANNED IMAGE AND SPECIFY FIRST SCAN AREA
S104 DETERMINE WHETHER OBJECT IS CD ON BASIS OF DIMENSIONS OF FIRST SCAN AREA
CD NOT CD
S106 READ FIRST SCAN AREA AT HIGH RESOLUTION TO ACQUIRE SECOND SCANNED IMAGE
S208 SPECIFY SECOND SCAN AREA BY REMOVING PREDETERMINED WIDTH OF PERIPHERY PART FROM FIRST SCAN AREA AND CUT OFF PART OF SHADOW AREA AND TRANSPARENT AREA BY REMOVING AREA CORRESPONDING TO PERIPHERAL PART OF SECOND SCAN AREA
S110 RESIZE SECOND SCANNED IMAGE IN SECOND SCAN AREA WITH DIFFERENT LONGIDUTINAL AND CROSS FACTORS ON BASIS OF DISTORTION CORRECTION INFORMATION AND CHANGE SHAPE OF SECOND SCANNED IMAGE TO SQUARE OF SIZE CORRESPONDING TO PRINT AREA
S112 CREATE PRINT OBJECT PAGE HAVING SUPERIMPOSED SCANNED IMAGE AND MASK ON BASIS OF TEMPLATE
S114 CREATE PRINT DATA OF PRINT OBJECT PAGE
S116 PRINT TO CDR ON BASIS OF PRINT DATA
END
S118 READ FIRST SCAN AREA AT HIGH RESOLUTION TO ACQUIRE SCANNED IMAGE
S120 CLIP AREAS CORRESPONDING TO FIRST SCAN AREA TO MAKE SECOND SCANNED IMAGE SQUARE
S122 RESIZE SECOND SCANNED IMAGE WITH EQUAL LONGIDUTINAL AND CROSS FACTORS IN ACCORDANCE WITH SQUARE PRINT AREA

FIG. 10
AUXILIARY SCANNING DIRECTION

FIG. 12
START
S300 ACCEPT OBJECT-DESIGNATING OPERATION AND SET TYPE OF OBJECT
S100 READ ENTIRE READABLE AREA AT LOW RESOLUTION TO ACQUIRE FIRST SCANNED IMAGE
S102 DIFFERENTIATE AREAS OF FIRST SCANNED IMAGE AND SPECIFY FIRST SCAN AREA
S304 IS OBJECT TYPE SET TO CD?
CD NOT CD
S106 READ FIRST SCAN AREA AT HIGH RESOLUTION TO ACQUIRE SECOND SCANNED IMAGE
S108 SPECIFY SECOND SCAN AREA BY REMOVING PREDETERMINED WIDTH OF END PART FROM FIRST SCAN AREA AND CUT OFF PART OF SHADOW AREA BY REMOVING AREA CORRESPONDING TO OUTSIDE OF SECOND SCAN AREA
S110 RESIZE SECOND SCANNED IMAGE IN SECOND SCAN AREA WITH DIFFERENT LONGIDUTINAL AND CROSS FACTORS ON BASIS OF DISTORTION CORRECTION INFORMATION AND CHANGE SHAPE OF SECOND SCANNED IMAGE TO SQUARE OF SIZE CORRESPONDING TO PRINT AREA
S112 CREATE PRINT OBJECT PAGE HAVING SUPERIMPOSED SCANNED IMAGE AND MASK ON BASIS OF TEMPLATE
S114 CREATE PRINT DATA OF PRINT OBJECT PAGE
S116 PRINT TO CDR ON BASIS OF PRINT DATA
END
S118 READ FIRST SCAN AREA AT HIGH RESOLUTION TO ACQUIRE SCANNED IMAGE
S120 CLIP AREAS CORRESPONDING TO FIRST SCAN AREA TO MAKE SECOND SCANNED IMAGE SQUARE
S122 RESIZE SECOND SCANNED IMAGE WITH EQUAL LONGIDUTINAL AND CROSS FACTORS IN ACCORDANCE WITH SQUARE PRINT AREA

1. An image processing system, comprising:
an image acquisition unit for acquiring a scanned image;
a first scan area specifying unit for specifying a first scan area corresponding to an object on the basis of the scanned image;
a recognizing unit for recognizing that the object is a known object; and
a second scan area specifying unit for specifying a second scan area obtained by removing from the first scan area at least a part of a shadow area presumed to correspond to a shadow of the known object.

2. An image processing system according to claim 1, wherein the first scan area specifying unit specifies the first scan area by area division of the scanned image.

3. An image processing system according to claim 1, wherein the recognizing unit recognizes that the object is the known object by a characteristic analysis of the scanned image in the first scan area.

4. An image processing system according to claim 1, wherein the recognizing unit accepts an object-designating operation and recognizes that the object is the known object in response to the object-designating operation.

5. An image processing system according to claim 1, further comprising a distortion correcting unit for correcting the ratio of a longitudinal direction length to a cross direction length of the scanned image in the second scan area by resizing it on the basis of preset distortion correction information.

6. An image processing system according to claim 1, wherein the image acquisition unit acquires the scanned image from an image reading device that reads an object placed on a transparent document bed and covered by a document backing mat and illuminated from a direction making a specified angle with a perpendicular line to the plate face of the document bed, and
the shadow area is an area predetermined in correspondence with the shape of the known object and the specified angle.

7. An image processing system according to claim 1, further comprising:
a reading unit for reading the known object and outputting the scanned image to the image acquisition unit; and
a printing unit for printing on the basis of print data created on the basis of the scanned image in the second scan area.

8. An image processing system according to claim 1, wherein the known object is annular in shape, further comprising a print data creating unit for, on the basis of the scanned image in the second scan area, creating print data in which areas corresponding to outside of an annular third area within the second scan area and concentric with the second scan area are masked as non-print areas.

9. An image processing system according to claim 1, wherein the known object is annular in shape, further comprising a transparency conversion unit for converting to transparent the scanned image outside of an annular area within the second scan area and concentric with the second scan area.

10. An image processing system according to claim 1, wherein the known object is a Compact Disc.

11. An image processing system, comprising:
an image acquisition unit for acquiring a scanned image;
a first scan area specifying unit for specifying a first scan area corresponding to an object on the basis of the scanned image;
a recognizing unit for recognizing that the object is a known object; and
a distortion correcting unit for correcting the ratio of a longitudinal direction length to a cross direction length of the scanned image in the first scan area by resizing on the basis of preset distortion correction information.

12. An image processing system according to claim 11, wherein the first scan area specifying unit specifies the first scan area by area division of the scanned image.

13. An image processing system according to claim 11, wherein the known object is annular in shape, further comprising a print data creating unit for, on the basis of the scanned image in the first scan area, creating print data in which areas corresponding to outside of an annular second scan area within the first scan area and concentric with the first scan area are masked as non-print areas.

14. An image processing system according to claim 11, wherein the known object is annular in shape, further comprising a transparency conversion unit for converting to transparent the scanned image outside of an annular second scan area within the first scan area and concentric with the first scan area.

15. An image processing system according to claim 11, further comprising:
a reading unit for reading the known object and outputting the scanned image to the image acquisition unit; and
a printing unit for printing on the basis of print data created on the basis of the scanned image in the first scan area.

16. An image processing system according to claim 11, wherein the recognizing unit recognizes that the object is the known object by a characteristic analysis of the scanned image in the first scan area.

17. An image processing system according to claim 11, wherein the recognizing unit accepts an object-designating user operation and recognizes that the object is the known object in response to the object-designating user operation.

18. An image processing system according to claim 11, wherein the known object is a Compact Disc.

19. An image processing method, comprising:
an image acquisition step of acquiring a scanned image;
a first scan area specifying step of specifying a first scan area corresponding to an object on the basis of the scanned image;
a recognizing step of recognizing that the object is a known object; and
a second scan area specifying step of specifying a second scan area obtained by removing from the first scan area at least a part of a shadow area presumed to correspond to a shadow of the known object.

20. An image processing method, comprising:
an image acquisition step of acquiring a scanned image;
a first scan area specifying step of specifying a first scan area corresponding to an object on the basis of the scanned image;
a recognizing step of recognizing that the object is a known object; and
a distortion correcting step of correcting the ratio of a longitudinal direction length to a cross direction length of the first scan area by resizing it on the basis of preset distortion correction information.
